(19) United States
(12) Patent Application Publication
(10) Pub. No.: US 2011/0005413 A1
(43) Pub. Date: Jan. 13, 2011

(54) ROTARY PRINTING PRESS

(75) Inventors: Koji Nishiyama, Hiroshima-ken (JP); Takayuki Sugahara, Hiroshima-ken (JP); Takanori Nitta, Hiroshima-ken (JP); Tetsushi Tomotaki, Hiroshima-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: Mitsubishi Heavy Industries Printing & Packing Machinery, Ltd., Hiroshima (JP)

(21) Appl. No.: 12/918,565

(22) PCT Filed: Jan. 14, 2009
(86) PCT No.: PCT/JP2009/050369

§ 371 Date: Aug. 20, 2010

(30) Foreign Application Priority Data
Feb. 22, 2008 (JP) 2008-042049

(51) Int. Cl. B41F 7/02

(52) U.S. Cl. 101/217

(57) ABSTRACT

In a rotary printing press that includes a blanket cylinder and a plate cylinder, the plate cylinder includes a plate cylinder body, a plate that is rolled around the plate cylinder body, and a plate insertion groove that is formed on a circumferential surface of the plate cylinder body along the axial direction thereof, and the blanket cylinder includes a blanket cylinder body, a blanket that is rolled around the blanket cylinder body, and a blanket insertion groove that is formed on a circumferential surface of the blanket cylinder body along an axial direction thereof. A groove opening width of the plate insertion groove and a groove opening width of the blanket insertion groove are reduced in a boundless manner.

### TECHNICAL FIELD

The present invention relates to a rotary printing press that performs a printing on a conveyed web by rotating a blanket cylinder and a plate cylinder.

### BACKGROUND ART

As a conventional rotary printing press, there has been known a rotary printing press including a blanket cylinder that is in rolling contact with a conveyed web and a plate cylinder that is in rolling contact with the blanket cylinder (see, for example, Patent Document 1).

The conventional rotary printing press is a so-called “4(W)×2(L) rotary printing press”, in which a diameter of the blanket cylinder is equal to a diameter of the plate cylinder. In the 4(W)×2(L) rotary printing press, a cylinder width W of the plate cylinder in its axial direction is as wide as four pages of a page width of a print page to be printed on the web, and a circumferential length L of the plate cylinder in its circumferential direction is as long as two pages of a page length of the print page to be printed on the web.

Patent Document 1: Japanese Patent Application Laid-open No. 2007-290187

### DISCLOSURE OF INVENTION

### Problem to be Solved by the Invention

The conventional rotary printing press such as the one described above is suitable for printing a large lot of prints at a high speed. However, in a case that the conventional rotary printing press is used for printing a small lot of prints, a plate rolled on the plate cylinder of the rotary printing press has been replaced by new one before it reaches the end of its life. That is, because the amount of prints output from the rotary printing press is small, the plate is less used, so that the plate is replaced by new one before it reaches the end of its life, often resulting in waste of the plate.

Accordingly, to suppress the waste of the plate and to meet the demand of a small lot of prints, a so-called “4(W)×1(L) rotary printing press” is used, in which the circumferential length L of the plate in its circumferential direction is as long as one page of the page length of the print page to be printed. Because the circumferential length of the plate of the 4(W)×1(L) rotary printing press is a half of that of the 4(W)×2(L) rotary printing press, the use of the plate can be doubled, making it possible to use the plate without any waste.

However, when the circumferential length of the plate is shortened, the plate cylinder becomes elongated (an elongated cylinder), and therefore the plate cylinder becomes more deflectable as compared to the conventional case, as the stiffness of the plate cylinder is degraded. When the plate cylinder becomes deflectable, for example, influence of a gap formed on the plate cylinder or the blanket cylinder becomes more prominent. The gap is a width of an opening of a groove for fixing a plate rolled on the plate cylinder or a blanket rolled on the blanket cylinder. Specifically, when the plate cylinder is rotated in rolling contact with the blanket cylinder while the gap of the blanket cylinder and the gap of the plate cylinder are facing each other, an impact is generated when the caps are facing each other, which causes a vibration of the plate cylinder of which the stiffness is degraded. When a printing is performed on a web in a state that the stiffness of the plate cylinder is degraded, the plate cylinder vibrates due to the influence of the gaps in a full speed range, by which a stripe pattern of gradation (so-called “shock grain”) is generated on a print page that is printed on the web or a print misalignment (out of registration) is generated, resulting in a degradation of its printing quality.

Therefore, an object of the present invention is to provide a rotary printing press in which a stable printing can be performed in a full speed range while maintaining its printing quality even when a plate cylinder is an elongated cylinder that is less stiff.

### Means for Solving Problem

According to an aspect of the present invention, a rotary printing press is configured to perform a printing on a conveyed web by rotating a blanket cylinder that is in rolling contact with the web and a plate cylinder that is in rolling contact with the blanket cylinder. The plate cylinder includes a plate cylinder body around which a plate is rolled, a plate insertion groove that is formed on a circumferential surface of the plate cylinder body along an axial direction thereof across a whole cylinder width thereof, into which a leading edge and a trailing edge of the plate can be inserted, and a plate tightening device that is configured to tighten and fix the plate on the plate cylinder body by latching the leading edge and the trailing edge of the plate that are inserted into the plate insertion groove. The plate cylinder body is configured to have W/L of equal to or larger 1.6, which is a value obtained by dividing a cylinder width W in the axial direction by a circumferential length L in a circumferential direction thereof. The plate tightening device includes a first latching unit that is formed in the plate insertion groove for latching the leading edge that is inserted into the plate insertion groove, and a tension bar that is arranged in the plate insertion groove extending in the axial direction of the plate cylinder body in a rotatable manner, the tension bar including a second latching unit that latches the trailing edge that is inserted into the plate insertion groove. The blanket cylinder includes a blanket cylinder body around which a blanket is rolled, a blanket insertion groove that is formed on a circumferential surface of the blanket cylinder body along an axial direction thereof, into which a leading edge and a trailing edge of the blanket can be inserted, and a blanket tightening device that is configured to tighten and fix the blanket on the blanket cylinder body by latching the leading edge and the trailing edge of the blanket that are inserted into the blanket insertion groove. The blanket includes a metal layer that takes an inner circumferential side of the blanket in a rolled state, and a blanket layer that takes an outer circumferential side of the blanket in the rolled state.

Advantageously, in the rotary printing press, the plate cylinder further includes a cocking device that is configured to adjust one end of the plate cylinder in a lifting direction that is perpendicular to a contacting direction with the blanket cylinder with respect to the blanket cylinder.

According to another aspect of the present invention, a rotary printing press is configured to perform a printing on a conveyed web by rotating a blanket cylinder that is in rolling contact with the web and a plate cylinder that is in rolling contact with the blanket cylinder. The plate cylinder includes a plate cylinder body around which a plate is rolled, a plate insertion groove that is formed on a circumferential surface of the plate cylinder body along an axial direction thereof across a whole cylinder width thereof, into which a leading edge and a trailing edge of the plate can be inserted, a plate tightening device is configured to tighten and fix the plate on the plate cylinder body by latching the leading edge and the trailing edge of the plate that are inserted into the plate insertion groove, and a cocking device is configured to adjust one end of the plate cylinder in a lifting direction that is perpendicular to a contacting direction with the blanket cylinder with respect to the blanket cylinder. The plate cylinder body is configured to have W/L of equal to or larger 1.6, which is a value obtained by dividing a cylinder width W in the axial direction by a circumferential length L in a circumferential direction thereof.

Advantageously, in the rotary printing press, the blanket cylinder includes a blanket cylinder body around which a blanket is rolled, a blanket insertion groove that is formed on a circumferential surface of the blanket cylinder body along an axial direction thereof, into which a leading edge and a trailing edge of the blanket can be inserted, and a blanket tightening device that is configured to tighten and fix the blanket on the blanket cylinder body by latching the leading edge and the trailing edge of the blanket that are inserted into the blanket insertion groove. The blanket includes a metal layer that takes an inner circumferential side of the blanket in a rolled state, and a blanket layer that takes an outer circumferential side of the blanket in the rolled state.

Advantageously, in the rotary printing press, the cocking device includes an eccentric shaft bearing that supports one end of a rotation shaft of the plate cylinder, and a rotating mechanism that rotates the eccentric shaft bearing around the rotation shaft.

Advantageously, in the rotary printing press, the rotating mechanism includes a cocking driving source for rotating the eccentric shaft bearing, and the cocking device further includes a cocking control unit that controls the cocking driving source.

Advantageously, the rotary printing press includes a lateral-registration correcting device that is arranged to approach the conveyed web, the lateral-registration correcting device restoring the web that is stretched in a width direction.

Advantageously, in the rotary printing press, the lateral-registration correcting device includes a roller group that is constituted by a plurality of rollers that can have a rolling contact with the conveyed web, the rollers being arranged in the width direction, and a roller-group moving mechanism that moves the roller group back and forth in a contacting direction with the web.

Advantageously, in the rotary printing press, the roller-group moving mechanism includes a lateral-registration correction driving source for moving the roller group back and forth in the contacting direction, and the lateral-registration correcting device further includes a lateral-registration-correction control unit that controls the lateral-registration correction driving source.

Advantageously, in the rotary printing press, the lateral-registration correcting device includes a nozzle group that is constituted by a plurality of nozzles that can blow an air against the conveyed web, the nozzles being arranged in the width direction of the web, and an air supplying unit that is configured to supply the air to the nozzle group through an air supplying path.

Advantageously, in the rotary printing press, a plurality of print pages of a predetermined size with a predetermined page width and a predetermined page length are printed on the web across a conveying direction and the width direction of the web after printing, and the plate cylinder body is formed such that the cylinder width in the axial direction is as wide as four pages of the page width and the circumferential length in the circumferential direction is as long as one page of the page length.

Advantageously, in the rotary printing press, the blanket cylinder includes a blanket cylinder body around which two blankets are rolled, two blanket insertion grooves that are formed on a circumferential surface of the blanket cylinder body along an axial direction thereof, into which a leading edge and a trailing edge of the blankets can be inserted, respectively. The blanket cylinder body is formed such that a cylinder width in the axial direction is as wide as four pages of the page width and a circumferential length in a circumferential direction thereof is as long as two pages of the page length, and each of the two blanket insertion grooves is formed with a length that is a half of the cylinder width of the blanket cylinder body. The two blanket insertion grooves are formed at positions facing each other across a rotation shaft of the blanket cylinder body, and one of the blanket insertion grooves is formed at one end side of the blanket cylinder body, and other of the blanket insertion grooves is formed at other end side of the blanket cylinder body.

### EFFECT OF THE INVENTION

According to the rotary printing press of claim 1, it is possible to tighten and fix a plate by a plate tightening device by inserting a leading edge and a trailing edge of a plate that is rolled around a plate cylinder body into a plate insertion groove formed across a whole cylinder width of the plate cylinder body. Therefore, because the plate insertion groove can be simply formed in a straight line across the whole cylinder width of the plate cylinder body when performing groove machining on the plate cylinder body, it is possible to perform the groove machining with a high precision. Furthermore, a plate cylinder is configured such that the plate is tightened and fixed on the plate cylinder body by latching the leading edge and the trailing edge of the plate on a first latching unit and a second latching unit, respectively, and rotating a tension bar. At this time, a tip structure of the second latching unit that holds the trailing edge of the plate is formed in an acute-angled shape, so that a bend allowance of the trailing edge of the plate can be reduced, which eliminates a necessity of increasing a groove opening width (gap) of the plate insertion groove, making it possible to reduce the gap in a boundless manner. In a blanket cylinder, an inner circumferential side of a blanket that is rolled around a blanket cylinder body is made of a metal layer, so that it is enough to insert only the metal layer of the blanket into a blanket insertion groove, which eliminates a necessity of increasing a groove opening width (gap) of the blanket insertion groove, making it possible to reduce the gap in a boundless manner. With this configuration, it is possible to reduce the gap of the plate cylinder and the gap of the blanket cylinder in a boundless manner. The smaller the gap is, the smaller the impact that is generated when passing through the gap. Therefore, in other words, because the plate cylinder can have a rolling contact with the blanket cylinder in a smooth manner, it is possible to reduce a vibration of the plate cylinder caused by the gap. Accordingly, it is possible to suppress a generation (shock grain) of a stripe pattern of gradation on a printed web. However, it is preferable to set the gap of the blanket cylinder somewhat larger than the gap of the plate cylinder. By doing so, even when an ink is attached inside the gap of the plate cylinder, because the gap of the blanket cylinder approaches a portion where the ink is attached, it is possible to suppress a transfer of the ink that is attached to the gap of the plate cylinder onto the blanket cylinder. The plate cylinder having W/L of equal to or larger 1.6 includes, for example, plate cylinders used in rotary printing presses of 4(W)×1(L) size, 6(W)×2(L) size, and 8(W)×2(L) size.

According to the rotary printing press of claim 2 and claim 3, it is possible to lift one end of the plate cylinder up and down by a cocking device with respect to the blanket cylinder, by which the plate cylinder can have a rolling contact with the blanket cylinder in an optimum state. That is, when the plate cylinder does not have a proper rolling contact with the blanket cylinder due to a mechanical error or a mounting error so that a print misalignment (registration twist) is generated on the web, it is possible to correct the print misalignment (registration twist) on the web by adjusting one end of the plate cylinder in a lifting direction by the cocking device, making it possible to perform a proper printing on the web.

According to the rotary printing press of claim 4, an inner circumferential side of a blanket that is rolled around a blanket cylinder body is made of a metal layer, so that it is enough to insert only the metal layer of the blanket into a blanket insertion groove, which eliminates a necessity of increasing a groove opening width (gap) of the blanket insertion groove, making it possible to reduce the gap in a boundless manner. Accordingly, the plate cylinder is less affected by the gap, and the vibration of the plate cylinder can be reduced, making it possible to suppress a generation of the stripe pattern of gradation (shock grain) on a printed web.

According to the rotary printing press of claim 5, because one end of the plate cylinder can be lifted up and down with a rotation of an eccentric shaft bearing by a rotating mechanism, the cocking device can be simplified.

According to the rotary printing press of claim 6, because a cocking driving source can be controlled by a cocking control unit, it is possible to perform a remote operation of the cocking device. With this configuration, when a print misalignment (registration twist) is generated on a printed web during an operation of the rotary printing press, it is possible to correct the print misalignment (registration misalignment or registration twist) of the web without suspending the rotary printing press by operating the cocking device in a remote manner.

According to the rotary printing press of claim 7, even when the web is stretched in the width direction (that is, a registration misalignment (fanout)), because the web can be restored to its original width by a lateral-registration correcting device, it is possible to correct the registration misalignment (fanout) and perform a proper printing on the web.

According to the rotary printing press of claim 8, it is possible to form a plurality of convex surfaces on the web by pressing a roller group against the web by a roller-group moving mechanism. Accordingly, a stretch of the web in the width direction can be shrunk, making it possible to restore the web W that is stretched in the width direction to its original width, that is, to correct the registration misalignment (fanout).

According to the rotary printing press of claim 9, because a lateral-registration correcting device can be controlled by a lateral-registration-correction control unit, the lateral-registration correcting device can be operated in a remote manner, making it possible to correct the registration misalignment (fanout) without suspending the rotary printing press.

According to the rotary printing press of claim 10, it is possible to for a plurality of convex surfaces on the web by blowing the air from a nozzle group. Accordingly, a stretch of the web in the width direction can be shrunk, making it possible to restore the web W that is stretched in the width direction to its original width, that is, to correct the registration misalignment (fanout).

According to the rotary printing press of claim 11, the plate cylinder can be configured in a 4(W)×1(L) size, making it possible to configure the rotary printing press to support a small lot of prints.

According to the rotary printing press of claim 12, because two blanket insertion grooves can be formed at positions on a circumferential surface facing each other across a rotation shaft of the blanket cylinder body, it is possible to make the blanket cylinder well balanced.

### BRIEF DESCRIPTION OF DRAWINGS

FIG. 1 is a schematic diagram of a newspaper offset rotary printing press to which a rotary printing press according to an embodiment of the present invention is applied.

FIG. 2 is a schematic diagram of a multicolor printing device.

FIG. 3 is a schematic diagram of a plate cylinder and a blanket cylinder.

FIG. 4 is an external perspective view of a plate cylinder body and a blanket cylinder body.

FIG. 5 is a side view of a cocking device and its surrounding elements.

FIG. 6 is an explanatory diagram of a gap of the plate cylinder and a gap of the blanket cylinder.

FIG. 7 is an external perspective view of a lateral-registration correcting device.

FIG. 8 is an external perspective view of a lateral-registration correcting device according to a modification.

### EXPLANATIONS OF LETTERS OR NUMERALS

10 rotary printing press printing device
16 multicolor printing device
20a, 20b, 20c, 20d four printing units
21 blanket cylinder
23 plate cylinder
30 plate cylinder body
32 plate
32 plate insertion groove
33 plate tightening device
37 leading edge of plate
38 trailing edge of plate
40 latching groove
41 tension bar
43 latching pawl
50 cocking device
51 double eccentric shaft bearing
55 inner eccentric shaft bearing
56 outer eccentric shaft bearing
57 fitting hole of inner eccentric shaft bearing
58 fitting hole of outer eccentric shaft bearing
60 outer rotating lever
61 outer-lever moving shaft
62 inner rotating lever
63 inner-lever moving shaft
64 cocking motor
65 cocking control unit
70 blanket cylinder body
71 blanket
72 blanket insertion groove
73 blanket tightening device
75 leading edge of blanket
76 trailing edge of blanket
82 metal layer
83 blanket layer
85 trailing-edge roll shaft
86 trailing-edge insertion groove
87 leading-edge latching unit
90 lateral-registration correcting device
91 roller group
92 roller-group moving mechanism
95 roller
100a, 100b lateral-registration correction motor
101a, 101b plate moving mechanism
102a, 102b lateral-registration-correction control unit
200 lateral-registration correcting device (according to modification)
201 nozzle group
203 air supplying device
204 blow nozzle
W web
G1 gap of plate insertion groove
G2 gap of blanket insertion groove

### BEST MODE(S) FOR CARRYING OUT THE INVENTION

Exemplary embodiments of a rotary printing press according to the present invention will be explained below in detail with reference to the accompanying drawings. The present invention is not limited to the embodiments.

### Embodiments

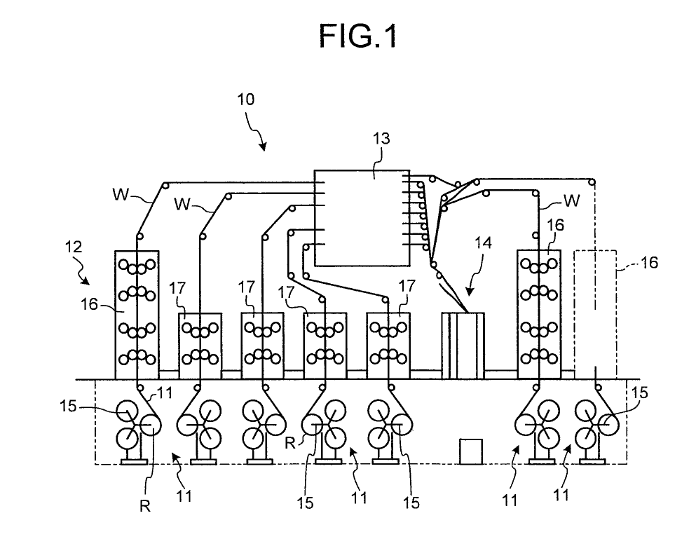

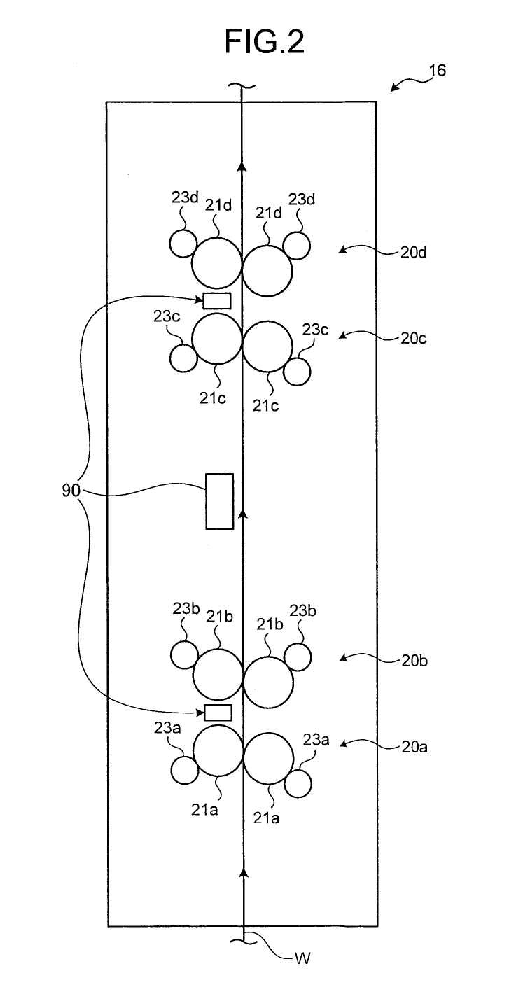

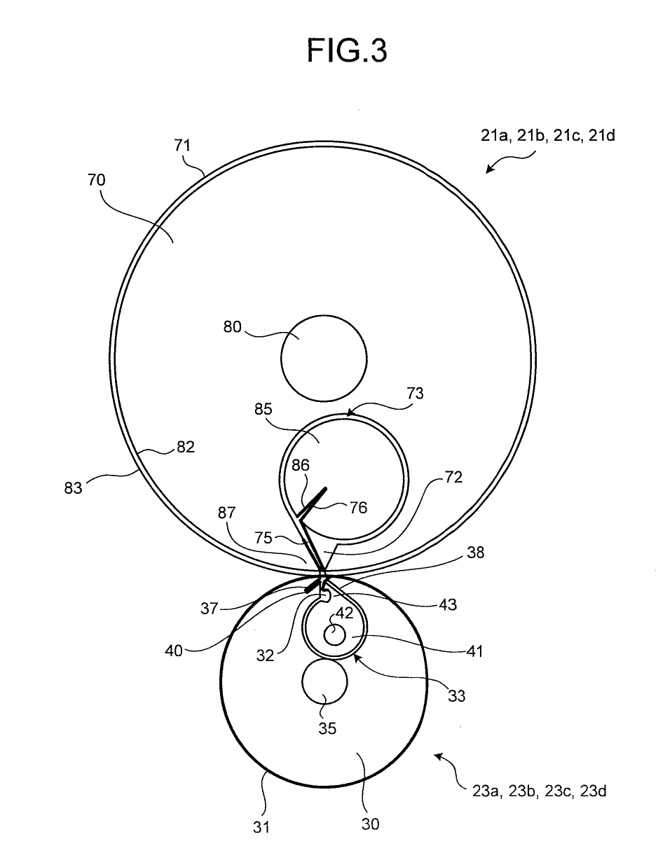

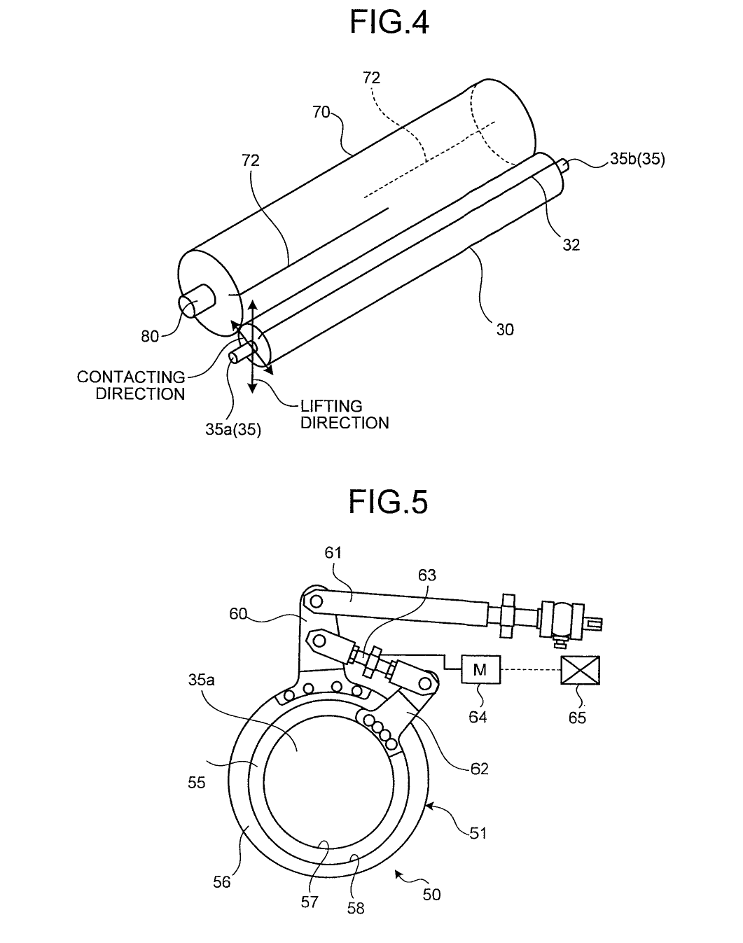

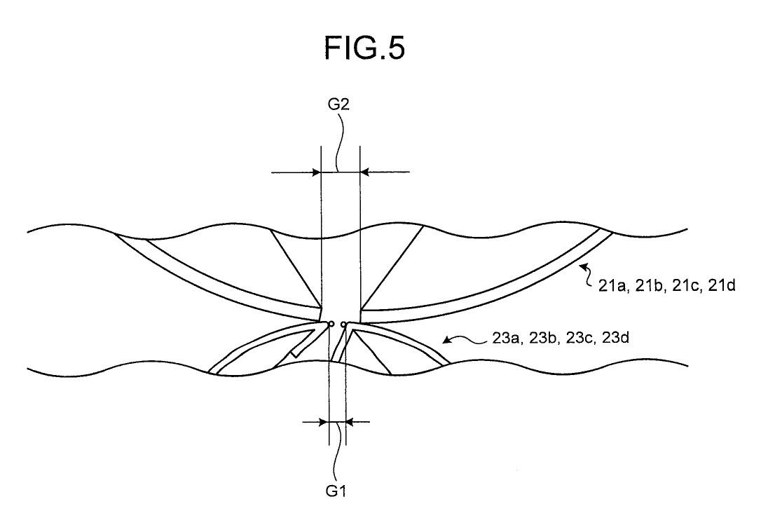

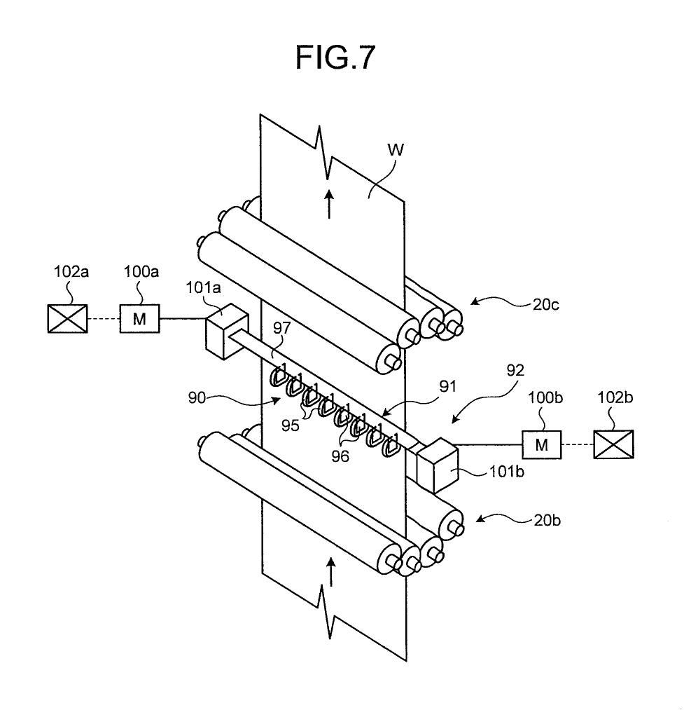

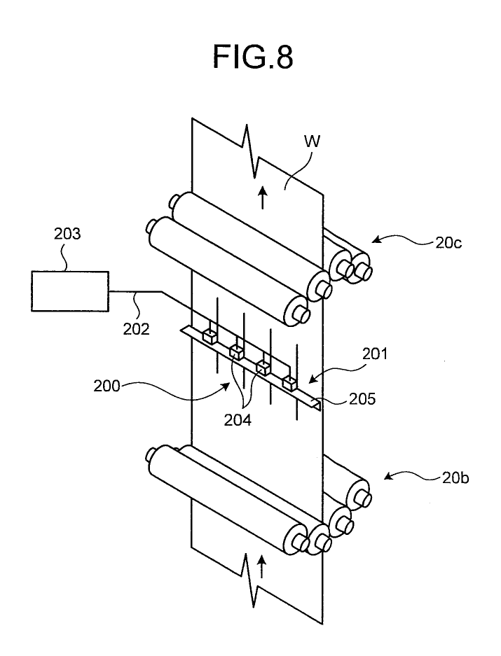

FIG. 1 is a schematic diagram of a newspaper offset rotary printing press to which a rotary printing press according to an embodiment of the present invention is applied and FIG. 2 is a schematic diagram of a multicolor printing device. FIG. 3 is a schematic diagram of a plate cylinder and a blanket cylinder and FIG. 4 is an external perspective view of a plate cylinder body and a blanket cylinder body. FIG. 5 is a side view of a cocking device and its surrounding elements and FIG. 6 is an explanatory diagram of a gap of the plate cylinder and a gap of the blanket cylinder. FIG. 7 is an external perspective view of a lateral-registration correcting device and FIG. 8 is an external perspective view of a lateral-registration correcting device according to a modification.

As shown in FIG. 1, a newspaper offset rotary printing press 10 that is adopted as a rotary printing press in the present embodiment includes a plurality of feeder devices 11, a printing device 12, a paper conveying device 13, and a folding device 14. Each of the feeder devices 11 includes three holding arms 15 that respectively hold three roll papers R each of which is formed by rolling the web W. By rotating the holding arms 15, it is possible to load the roll paper R to a feeding position. Each of the feeder devices 11 includes a paper patching device (not shown). When the roll paper R that is fed from the feeder device draws to an end, it is possible to patch a roll paper R that is at a standby position to the roll paper R at the feeding position by the paper patching device.

The printing device 12 includes a multicolor printing device 16 that performs a perfecting four color printing and a two color printing device 17 that performs a perfecting two color printing. The multicolor printing device 16 and the two color printing device 17 can perform predetermined printings on the web W that is supplied from each of the feeder devices 11. Although the printing device 12 is constituted by the multicolor printing device 16 and the two color printing device 17 in the present embodiment, it is not limited to this configuration. For example, various printing devices can be used by being appropriately combined according to a target printed matter, such as a perfecting single color printing device that performs a perfecting single color printing and a multicolor printing device that performs a single-sided four color or two color printing.

The paper conveying device 13 includes, although not shown, a plurality of cutters that cuts the web W at its center along a conveying direction of conveying the web W, a plurality of guide rollers and dampers for setting a conveying path for conveying the web W that is cut by the cutter, a slitter device and the like. Therefore, each of printed webs W on which a printing is performed by the printing device 12 is cut by the cutter and its conveying path is changed by the damper at the paper conveying device 13, so that the printed webs W can be stacked in a predetermined order.

The folding device 14 folds a plurality of webs W fed from the paper conveying device 13 in the longitudinal direction, cuts the folded webs W by a predetermined length in the lateral direction, further folds them in the lateral direction to form a desired fold format, and then delivers them in the desired fold format.

The printing device 12 is explained in detail below with reference to FIG. 2. The multicolor printing device 16 is used in the following explanations as an example of the printing device 12.

The multicolor printing device 16 includes four printing units 20a, 20b, 20c, and 20d for four ink colors C (Cyan), M (Magenta), Y (Yellow), and K (Black), respectively. The four printing units 20a, 20b, 20c, and 20d are arranged in the order of the cyan printing unit 20a, the magenta printing unit 20b, the yellow printing unit 20c, and the black printing unit 20d from an upstream of the conveying direction of the web W. The order of arranging the printing units 20a, 20b, 20c, and 20d is not limited to any particular order, but they can be arranged in a desired order as needed. The printing units 20a, 20b, 20c, and 20d are configured to simultaneously perform printings on a front side and a back side of the web W. With the printings on the web W by the printing units 20a, 20b, 20c, and 20d, a plurality of print pages of a predetermined size with a predetermined page width and a predetermined page length become printed in the conveying direction and the width direction of the web W.

Each of the printing units 20a, 20b, 20c, and 20d includes a pair of blanket cylinders 21a, 21b, 21c, and 21d facing each other across the web W and a pair of plate cylinders 23a, 23b, 23c, and 23d having contact with the blanket cylinders 21a, 21b, 21c, and 21d, respectively. The pair of blanket cylinders 21a of the cyan printing unit 20a and the pair of blanket cylinders 21b of the magenta printing unit 20b are placed close to each other, and the pair of blanket cylinders 21c of the yellow printing unit 20c and the pair of blanket cylinders 21d of the black printing unit 20d are placed close to each other. Although details thereof are described later, three lateral-registration correcting devices 90 for restoring the web that is extended in the width direction are arranged between the printing units 20a, 20b, 20c, and 20d, respectively.

As shown in FIGS. 3 and 4, the plate cylinders 23a, 23b, 23c, and 23d of the printing units 20a, 20b, 20c, and 20d have the same configuration, and explanations are given for the plate cylinder 23a as an example. However, reference numerals of the plate cylinders in the drawings are denoted as 23a, 23b, 23c, and 23d. The plate cylinder 23a includes a plate cylinder body 30, four plates 31 that are rolled around the plate cylinder body 30, a plate insertion groove 32 that is formed on a circumferential surface of the plate cylinder body 30 along the axial direction thereof, and a plate tightening device 33 that can tighten and fix the plates 31 on the plate cylinder body 30.

The plate cylinder body 30 includes a rotation shaft 35 at its axis center. One end 35a of the rotation shaft 35 is supported by a double eccentric shaft bearing 51 that is described later (see FIG. 5), and other end 35b of the rotation shaft 35 is supported by a single eccentric shaft bearing that is described later. The plate cylinder body 30 is configured to rotate with a driving force from a driving device (not shown). A cylinder width W of the plate cylinder body 30 in the axial direction is as wide as four pages of a page width of a print page, and a circumferential length L of the plate cylinder body 30 is as long as one page of a page length of the print page. That is, the plate cylinder body 30 is configured in a 4(W)×1(L) size. A ratio W/L obtained by dividing the cylinder width W by the circumferential length L is equal to or larger than 1.6. A cylinder having W/L of equal to or larger 1.6 is defined as the elongated cylinder.

Each of the plates 31 to be rolled around the plate cylinder body 30 is formed in the same size as a size of the print page. The four plates 31 are rolled around the plate cylinder body 30 side by side in the axial direction. That is, with one rotation of the plate cylinder 23a, four print pages are transferred in the axial direction of the blanket cylinder 21a.

As shown in FIG. 4, the plate insertion groove 32 that is formed on the plate cylinder body 30 is formed in a straight line across the whole cylinder width of the plate cylinder body 30. Therefore, because the plate insertion groove 32 can be simply formed in a straight line across the whole cylinder width of the plate cylinder body 30 when performing groove machining on the plate cylinder body 30, it is possible to perform the groove machining with a high precision. A leading edge 37 and a trailing edge 38 of each of the plates 31 are inserted into the plate insertion groove 32.

The plate tightening device 33 includes a latching groove 40 (a first latching unit) that is formed in the plate insertion groove 32 for latching the leading edge 37 of each of the plates 31 and a tension bar 41 that is arranged in the plate insertion groove 32 extending in the axial direction of the plate cylinder body 30 in a rotatable manner.

The latching groove 40 is formed near an opening of the plate insertion groove 32. The latching groove 40 and a circumferential surface of the plate cylinder body 30 makes an acute angle. The leading edge 37 of each of the plates 31 is formed in a curved manner, so that when the leading edge 37 of each of the plates 31 is inserted into the latching groove 40, the leading edge 37 of each of the plates 31 is caught in the latching groove 40, by which the leading edge 37 of each of the plates 31 is latched.

The tension bar 41 includes a rotation shaft 42 at its axis center, being formed in a rotatable manner. A latching pawl 43 (a second latching unit) is formed on a circumferential portion of the tension bar 41, which is bent in a direction of rolling each of the plates 31. A tip portion of the latching pawl 43 is formed at an acute angle. The trailing edge 38 of each of the plates 31 is latched on the latching pawl 43.

When fixing the plate 31 on the plate cylinder body 30 by the plate tightening device 33, first, the leading edge 37 of the plate 31 is inserted and latched into the latching groove 40. Subsequently, the plate cylinder body 30 is rotated to roll the plate 31 around the plate cylinder body 30, and then the trailing edge 38 of the plate 31 is latched on the latching pawl 43. By rotating the tension bar 41 in a tightening direction in this state, it is possible to tighten and fix the plate 31 on the plate cylinder body 30. With the plate tightening device 33, because a bend allowance of the trailing edge of the plate 31 can be reduced by making the latching pawl 43 an acute-angled structure, it is possible to reduce a groove opening width (a gap G1: see FIG. 6) of the plate insertion groove 32 in a boundless manner. For example, it is possible to reduce the gap G1 down to about 2 millimeters.

As shown in FIG. 5, the plate cylinder 23a includes a cocking device 50. The cocking device 50 adjusts a position of the plate cylinder 23a by lifting up and down one end of the plate cylinder 23a in a lifting direction (a radial direction) that is perpendicular to a contacting direction with the blanket cylinder 21a, so that the plate cylinder 23a can have a rolling contact with the blanket cylinder 21a in an optimum state. That is, at the time of an initial setting of the rotary printing press 10, the plate cylinder 23a may not have a proper rolling contact with the blanket cylinder 21a due to a mechanical error or a mounting error. In such a case, because it may result in an occurrence of a print misalignment (registration twist) on the web W, it is possible to correct the print misalignment (registration twist) on the web W by adjusting one end of the plate cylinder 23a in the lifting direction by the cocking device 50. Details on the cocking device 50 are explained below.

As described above, the one end 35a of the rotation shaft 35 of the plate cylinder body 30 is supported by the double eccentric shaft bearing 51 while the other end 35b is supported by the single eccentric shaft bearing (not shown). The single eccentric shaft bearing and the double eccentric shaft bearing 51 can move the plate cylinder 23a in the contacting direction with respect to the blanket cylinder 21a and to lift one end of the plate cylinder 23a up and down in the lifting direction. That is, the single eccentric shaft bearing and the double eccentric shaft bearing 51 serve as a print pressure adjusting device that adjusts a print pressure of the plate cylinder 23a with respect to the blanket cylinder 21a, while serving as the cocking device 50.

Although not shown, the single eccentric shaft bearing is formed in a circular shape in a planar view. A circular fitting hole in which the other end 35b of the rotation shaft 35 of the plate cylinder body 30 is fitted is formed at the center of the single eccentric shaft bearing in an eccentric manner. The other end 35b of the rotation shaft 35 of the plate cylinder body 30 is supported by being fitted in the fitting hole. Furthermore, a bearing is arranged between the single eccentric shaft bearing and the other end 35b of the rotation shaft 35, so that the single eccentric shaft bearing can be freely rotate with respect to the other end 35b of the rotation shaft 35.

On the other hand, the double eccentric shaft bearing 51 shown in FIG. 5 is constituted by an inner eccentric shaft bearing 55 (an eccentric shaft bearing) that supports the one end 35a of the rotation shaft 35 of the plate cylinder body 30 and an outer eccentric shaft bearing 56 that supports the inner eccentric shaft bearing 55. The inner eccentric shaft bearing 55 is formed in a circular shape in a planar view, similar to the single eccentric shaft bearing. A circular fitting hole 57 in which the one end 35a of the rotation shaft 35 of the plate cylinder body 30 is fitted is formed at the center of the inner eccentric shaft bearing 55 in an eccentric manner. The one end 35a of the rotation shaft 35 is supported by being fitted in the fitting hole. A bearing (not shown) is arranged between the inner eccentric shaft bearing 55 and the one end 35a of the rotation shaft 35.

The outer eccentric shaft bearing 56 is formed in a circular shape in a planar view with a larger diameter than that of the inner eccentric shaft bearing 55. A circular fitting hole 58 in which the inner eccentric shaft bearing 55 is fitted is formed at the center of the outer eccentric shaft bearing 56 in an eccentric manner. By the inner eccentric shaft bearing 55 being fitted in the fitting hole 58, the inner eccentric shaft bearing 55 and the one end 35a of the rotation shaft 35 can be supported. A bearing (now shown) or a lubricating member is arranged between the outer eccentric shaft bearing 56 and the inner eccentric shaft bearing 55.

With this configuration, the outer eccentric shaft bearing 56 is configured to freely rotate with respect to the one end 35a of the rotation shaft 35 of the plate cylinder body 30 and the inner eccentric shaft bearing 55, and similarly, the inner eccentric shaft bearing 55 is configured to freely rotate with respect to the one end 35a of the rotation shaft 35 of the plate cylinder body 30 and the outer eccentric shaft bearing 56.

An outer rotating lever 60 for rotating the outer eccentric shaft bearing 56 is fixed with a bolt on an edge of the outer eccentric shaft bearing 56. The outer rotating lever 60 is mounted protruding outward in the radial direction of the outer eccentric shaft bearing 56. A distal end of an outer-lever moving shaft 61 that moves the outer rotating lever 60 in its rotating direction is connected to an outer end of the outer rotating lever 60, and a base end of the outer-lever moving shaft 61 is fixed to a frame (not shown). The outer-lever moving shaft 61 is configured in an extendable and retractable manner, and therefore it is possible to rotate the outer rotating lever 60 by extending and retracting the outer-lever moving shaft 61.

An inner rotating lever 62 for rotating the inner eccentric shaft bearing 55 is fixed with a bolt on an edge of the inner eccentric shaft bearing 55. The inner rotating lever 62 is mounted protruding outward in the radial direction of the inner eccentric shaft bearing 55. A base end of an inner-lever moving shaft 63 that moves the inner rotating lever 62 in its rotating direction is connected to an outer end of the inner rotating lever 62, and a distal end of the inner-lever moving shaft 63 is connected to a center portion of the outer rotating lever. The inner-lever moving shaft 63 is configured in an extendable and retractable manner, and therefore it is possible to rotate the inner rotating lever 62 by extending and retracting the inner-lever moving shaft 63.

In this case, when the outer rotating lever 60 is rotated by extending and retracting the outer-lever moving shaft 61, because the outer rotating lever 60 is connected to the inner rotating lever 62 by the inner-lever moving shaft 63, the outer eccentric shaft bearing 56 is rotated together with the inner eccentric shaft bearing 55. On the other hand, when the inner rotating lever 62 is rotated by extending and retracting the inner-lever moving shaft 63, because the inner rotating lever 62 is connected to the outer rotating lever 60 by the inner-lever moving shaft 63, the inner eccentric shaft bearing 55 is rotated separately from the outer eccentric shaft bearing 56.

In a case of adjusting the print pressure of the plate cylinder 23a with respect to the blanket cylinder 21a, that is, when the single eccentric shaft bearing and the double eccentric shaft bearing 51 serve as the print pressure adjusting device, it is possible to move the plate cylinder 23a in the contacting direction by rotating the outer eccentric shaft bearing 56 and the inner eccentric shaft bearing 55 by rotating the outer rotating lever 60 with the outer-lever moving shaft 61 and rotating the single eccentric shaft bearing, by which the print pressure can be adjusted. On the other hand, in a case of correcting the print misalignment (registration twist) of the web W, that is, when the single eccentric shaft bearing and the double eccentric shaft bearing 51 serve as the cocking device 50, it is possible to move the one end 35a of the plate cylinder 23a in the lifting direction by rotating the inner eccentric shaft bearing 55 by rotating the inner rotating lever 62 with the inner-lever moving shaft 63, by which the print misalignment (registration twist) can be corrected.

The cocking device 50 includes a cocking motor 64 (a cocking driving source) for extending and retracting the inner-lever moving shaft 63 and a cocking control unit 65 that controls the cocking motor 64.

The cocking control unit 65 is included in a control device (not shown) that controls the rotary printing press 10. By controlling the cocking motor 64 with the cocking control unit 65, it is possible to control one end of the plate cylinder 23a in an up and down manner. With this configuration, because it is possible to perform a remote operation of the cocking device 50 by operating the control device, the print misalignment (registration twist) of the web W can be corrected without suspending the rotary printing press 10.

Referring back to FIGS. 3 and 4, the blanket cylinders 21a, 21b, 21c, and 21d of the printing units 20a, 20b, 20c, and 20d are explained next. The blanket cylinders 21a, 21b, 21c, and 21d have the same configuration, and explanations are given for the blanket cylinder 21a as an example. However, reference numerals of the blanket cylinders in the drawings are denoted as 21a, 21b, 21c, and 21d. The blanket cylinder 21a includes a blanket cylinder body 70, two blankets 71 (one of the two blankets is shown) that are rolled around the blanket cylinder body 70, two blanket insertion grooves 72 that are formed on a circumferential surface of the blanket cylinder body 70 along the axial direction thereof, and a blanket tightening device 73 that can respectively tighten and fix the blankets 71 on the blanket cylinder body 70. A leading edge 75 and a trailing edge 76 of each of the blankets 71 are inserted into each of the blanket insertion grooves 72.

The blanket cylinder body 70 includes a rotation shaft 80, and is configured to rotate with a driving force from a driving device (not shown). A cylinder width W of the blanket cylinder body 70 in the axial direction is as wide as four pages of a page width of a print page, and a circumferential length L of the blanket cylinder body 70 is as long as two pages of a page length of the print page. That is, the blanket cylinder body 70 is configured in a 4(W)×2(L) size. A ratio W/L obtained by dividing the cylinder width W by the circumferential length L is smaller than 1.6. That is, the blanket cylinder body 70 is configured to be thicker than the plate cylinder body 30 that is elongated. With this configuration, when the plate cylinder 23 and the blanket cylinder 21 are rotated in synchronization with each other, the plate cylinder 23a will make two cycles of rotation while the blanket cylinder 21a makes one cycle of rotation.

A size of each of the blankets 71 that are rolled around the blanket cylinder body 70 is equal to two pages of the page width of the print page in the width direction and two pages of the page length of the print page in the circumferential direction. Furthermore, in a state that each of the blankets 71 is rolled around the blanket cylinder body 70, the blanket 71 is constituted by a metal layer 82 on its inner circumference and a blanket layer 83 on its outer circumference, forming a so-called “metal back blanket”. The leading edge 75 and the trailing edge 76 of each of the blankets 71 are constituted only by the metal layer 82, so that only the metal layer 82 is inserted into each of the blanket insertion grooves 72.

As shown in FIG. 4, each of the blanket insertion grooves 72 formed on the blanket cylinder body 70 is formed with a length that is a half of a cylinder width of the blanket cylinder body 70. The two blanket insertion grooves 72 are formed at positions facing each other across the rotation shaft 80. One of the blanket insertion grooves 72 is formed at one end side of the blanket cylinder body 70, and the other of the blanket insertion grooves 72 is formed at the other end side of the blanket cylinder body 70. With this configuration, because the two blanket insertion grooves 72 can be arranged in a balanced manner, it is possible to make the blanket cylinder 21 well balanced.

The blanket tightening device 73 includes two trailing-edge roll shafts 85 respectively arranged in the two blanket insertion grooves 72. Each of the trailing-edge roll shafts 85 is arranged in each of the blanket insertion grooves 72 extending in the axial direction of the blanket cylinder body 70. A trailing-edge insertion groove 86 into which the trailing edge 76 of each of the blankets 71 is inserted is formed on each of the trailing-edge roll shafts 85 along the axial direction, and a holding member (not shown) that latches the trailing edge 76 of the blanket 71 is provided in the trailing-edge insertion groove 86. On the other hand, a leading-edge latching unit 87 that latches the leading edge 75 of the blanket 71 is provided at an opening edge of the blanket insertion groove 72. That is, a circumferential surface of the blanket cylinder body 70 and an inner surface near an opening of each of the blanket insertion grooves 72 make an acute angle. The leading edge 75 of the blanket 71 is formed in a curved manner, so that the leading edge of the blanket 71 is caught on the opening edge of the blanket insertion groove 72, by which the leading edge 75 of the blanket 71 is latched.

When fixing the blanket 71 on the blanket cylinder body 70 by the blanket tightening device 73, first, the leading edge 75 of the blanket 71 is latched on the leading-edge latching unit 87. Subsequently, the blanket cylinder body 70 is rotated to roll the blanket 71 around the blanket cylinder body 70, and then the trailing edge 76 of the blanket 71 is inserted into the trailing-edge insertion groove 86 to be latched on the holding member. By rotating the trailing-edge roll shafts 85 in a tightening direction in this state, it is possible to tighten and fix the blanket 71 on the blanket cylinder body 70. With this blanket 71, because it is enough to simply insert the metal layer 82 of the blanket 71 in each of the blanket insertion grooves 72, it is possible to reduce a groove opening width (a gap G2: see FIG. 6) of each of the blanket insertion grooves 72 in a boundless manner. For example, it is possible to reduce the gap G2 down to about 2 millimeters.

With this configuration, because it is possible to reduce the gap G1 of the plate cylinder 23a and the gap G2 of the blanket cylinder 21a in a boundless manner, the plate cylinder 23a becomes less likely to be affected by the gap, making it possible to reduce a vibration of the plate cylinder 23a due to each of the gaps G1 and G2. As a result, it is possible to suppress a generation of the stripe pattern of gradation (shock grain) on a printed web W, which is caused by a vibration of the plate cylinder 23a. The plate cylinder 23a and the blanket cylinder 21a are rotated in synchronization with each other by facing the gap G1 of the plate cylinder 23a and the gap G2 of the blanket cylinder 21a each other.

In this case, although the gap G1 of the plate cylinder 23a and the gap G2 of the blanket cylinder 21a are 2 millimeters in the above description, as shown in FIG. 6, it is preferable to set the gap G2 of the blanket cylinder 21a somewhat larger than the gap G1 of the plate cylinder 23a. By doing so, even when an ink is attached inside the gap G1 of the plate cylinder 23a, because the gap G2 of the blanket cylinder 21a approaches a portion where the ink is attached, it is possible to suppress a transfer of the ink that is attached to the gap G1 of the plate cylinder 23a onto the blanket cylinder 21a.

The three lateral-registration correcting devices 90 are explained next with reference to FIG. 7. As described above, the lateral-registration correcting devices 90 are respectively arranged between the cyan printing unit 20a and the magenta printing unit 20b, between the magenta printing unit 20b and the yellow printing unit 20c, and between the yellow printing unit 20c and the black printing unit 20d. Each of the lateral-registration correcting devices 90 restores the web W that is stretched in the width direction to a width of the web W before printing. For example, when a printing is performed on the conveyed web W by the cyan printing unit 20a and the magenta printing unit 20b, the web W will contain ink, moisture and the like, resulting in a stretch of the web W in the width direction, that is, a registration misalignment (fanout) is generated. When a further printing is performed on the web W in this state by the yellow printing unit 20c and the black printing unit 20d, a print misalignment (fanout) is generated on the web W. For this reason, by restoring the web W that is stretched in the width direction to the width of the web W before printing by the lateral-registration correcting devices 90, that is, correcting the registration misalignment (fanout), it becomes possible to perform a printing on the web W in a proper manner. Similarly, a registration misalignment (fanout) of the same sort is also generated between the cyan printing unit 20a and magenta printing unit 20b and between the yellow printing unit 20c and the black printing unit 20d. Details are explained below with the lateral-registration correcting device 90 arranged between the magenta printing unit 20b and the yellow printing unit 20c as an example.

The lateral-registration correcting device 90 includes a roller group 91 that is arranged across the width direction of the web W and a roller-group moving mechanism 92 that moves the roller group 91 back and forth in a contacting direction with the web W.

The roller group 91 is constituted by a plurality of rollers 95 that are arranged on the same axis at an equal interval, a plurality of shaft bearings 96 each supporting a rotation shaft of each of the rollers 95, and a roller plate 97 to which the shaft bearings 96 are fixed. The roller plate 97 is formed in a rectangular shape in a planar view. The longitudinal direction of the roller plate 97 is arranged in the same direction as the width direction of the web W. The rollers 95 are arranged such that their axial directions are the same as the width direction of the web W, and the shaft bearings 96 are arranged in the longitudinal direction of the roller plate 97 at an equal interval.

The roller-group moving mechanism 92 includes two lateral-registration correction motors 100a and 100b (lateral-registration correction driving sources) as driving sources and a pair of plate moving mechanisms 101a and 101b that moves both sides of the roller plate 97 in a contacting direction with the web W by driving forces from the lateral-registration correction motors 100a and 100b, respectively. When the web W is stretched in the width direction, that is, when a registration misalignment is generated, the roller-group moving mechanism 92 presses the rollers 95 against the web W by moving the roller group 91 toward the web W. Upon the rollers 95 being pressed against the web W, a plurality of convex surfaces are formed on the web W, by which the web W that is stretched in the width direction becomes shrunk to be restored to the web W before printing, which makes it possible to correct the registration misalignment.

The lateral-registration correcting device 90 further includes lateral-registration-correction control units 102a and 102b that controls the lateral-registration correction motors 100a and 100b, respectively, which are included in a control device (not shown). By controlling the lateral-registration correction motors 100a and 100b using the lateral-registration-correction control units 102a and 102b, it is possible to move the roller group 91 in the contacting direction. With this configuration, because it is possible to perform a remote operation of the lateral-registration correcting device 90 by operating the control device, the registration misalignment (fanout) of the web W can be corrected without suspending the rotary printing press 10.

With the above configuration, the gap G1 of the plate cylinder 23a and the gap G2 of the blanket cylinder 21a can be reduced in a boundless manner as compared to the conventional case, and therefore it is possible to make the plate cylinder 23a less affected by the gaps G1 and G2. That is, by reducing the gaps G1 and G2, it is possible to perform the rotation of the plate cylinder 23a that has a rolling contact with the blanket cylinder 21a in a smooth manner. As a result, the vibration of the plate cylinder 23 due to each of the gaps G1 and G2 can be reduced, making it possible to suppress a generation of the stripe pattern of gradation on a printed web W.

By providing the cocking device 50, even when a print misalignment (registration twist) is generated on the web W, it is possible to correct the print misalignment (registration twist) on the web W by adjusting one end of the plate cylinder 23 in the lifting direction.

Furthermore, by providing the lateral-registration correcting device 90, even when a registration misalignment (fanout) is generated on the web W, it is possible to correct the registration misalignment (fanout) because the web W that is stretched in the width direction can be restored to the web W before printing.

In the present embodiment, although the plate cylinder 23a is configured in a 4(W)×1(L) size, because it is only required that W/L be equal to or larger than 1.6, the present invention can also be applied to, for example, a 6(W)×2(L) size or an 8(W)×2(L) size. The lateral-registration correcting device 90 included in the rotary printing press 10 according to the present embodiment corrects the registration misalignment (fanout) by pressing the roller group 91 against the web W. However, as shown in FIG. 8, the registration misalignment (fanout) can be corrected by blowing an air against the web W.

Specifically, a lateral-registration correcting device 200 according to a modification of the embodiment shown in FIG. 8 includes a nozzle group 201 that is constituted by a plurality of blow nozzles 204 that can blow the air against the web W, being arranged in the width direction of the web W, and an air supplying device 203 that supplies the air to the blow nozzles 204 through an air supplying path 202. The nozzle group 201 is constituted by the blow nozzles 204 that are arranged at an equal interval across the width direction of the web W and a nozzle holding plate 205 that holds the blow nozzles 204.

When the web W is stretched in the width direction, that is, when a registration misalignment (fanout) is generated, the air supplying device 203 supplies the air to the blow nozzles 204, by which the air is blown from the blow nozzles 204. The air is then blown against the web W from the blow nozzles 204, by which a plurality of convex surfaces are formed on the web W. As a result, the web W that is stretched in the width direction becomes shrunk to be restored to the web W before printing, which makes it possible to correct the registration misalignment.

### INDUSTRIAL APPLICABILITY

As described above, the rotary printing press according to the present invention is useful for rotary printing presses configured by a plate cylinder or a blanket cylinder, and is particularly suitable to rotary printing presses having a plate cylinder, which is an elongated cylinder.

1. A rotary printing press, comprising:
a blanket cylinder that is in rolling contact with a conveyed web; and
a plate cylinder that is in rolling contact with the blanket cylinder,
wherein the plate cylinder includes
a plate cylinder body around which a plate is rolled,
a plate insertion groove that is formed on a circumferential surface of the plate cylinder body along an axial direction thereof across a whole cylinder width thereof, into which a leading edge and a trailing edge of the plate can be inserted, and
a plate tightening device that is configured to tighten and fix the plate on the plate cylinder body by latching the leading edge and the trailing edge of the plate that are inserted into the plate insertion groove,
the plate cylinder body is configured to have W/L of equal to or larger 1.6, which is a value obtained by dividing a cylinder width W in the axial direction by a circumferential length L in a circumferential direction thereof,
the plate tightening device includes
a first latching unit that is formed in the plate insertion groove for latching the leading edge that is inserted into the plate insertion groove, and
a tension bar that is arranged in the plate insertion groove extending in the axial direction of the plate cylinder body in a rotatable manner, the tension bar including a second latching unit that latches the trailing edge that is inserted into the plate insertion groove,
the blanket cylinder includes
a blanket cylinder body around which a blanket is rolled,
a blanket insertion groove that is formed on a circumferential surface of the blanket cylinder body along an axial direction thereof, into which a leading edge and a trailing edge of the blanket can be inserted, and
a blanket tightening device that is configured to tighten and fix the blanket on the blanket cylinder body by latching the leading edge and the trailing edge of the blanket that are inserted into the blanket insertion groove, and
the blanket includes
a metal layer that takes an inner circumferential side of the blanket in a rolled state, and
a blanket layer that takes an outer circumferential side of the blanket in the rolled state.

2. The rotary printing press according to claim 1, wherein the plate cylinder further includes a cocking device that is configured to adjust one end of the plate cylinder in a lifting direction that is perpendicular to a contacting direction with the blanket cylinder with respect to the blanket cylinder.

3. A rotary printing press, comprising:
a blanket cylinder that is in rolling contact with a conveyed web; and
a plate cylinder that is in rolling contact with the blanket cylinder,
wherein the plate cylinder includes
a plate cylinder body around which a plate is rolled,
a plate insertion groove that is formed on a circumferential surface of the plate cylinder body along an axial direction thereof across a whole cylinder width thereof, into which a leading edge and a trailing edge of the plate can be inserted,
a plate tightening device that is configured to tighten and fix the plate on the plate cylinder body by latching the leading edge and the trailing edge of the plate that are inserted into the plate insertion groove, and
a cocking device that is configured to adjust one end of the plate cylinder in a lifting direction that is perpendicular to a contacting direction with the blanket cylinder with respect to the blanket cylinder, and
the plate cylinder body is configured to have W/L of equal to or larger 1.6, which is a value obtained by dividing a cylinder width W in the axial direction by a circumferential length L in a circumferential direction thereof.

4. The rotary printing press according to claim 3, wherein
the blanket cylinder includes
a blanket cylinder body around which a blanket is rolled,
a blanket insertion groove that is formed on a circumferential surface of the blanket cylinder body along an axial direction thereof, into which a leading edge and a trailing edge of the blanket can be inserted, and
a blanket tightening device that is configured to tighten and fix the blanket on the blanket cylinder body by latching the leading edge and the trailing edge of the blanket that are inserted into the blanket insertion groove, and
the blanket includes
a metal layer that takes an inner circumferential side of the blanket in a rolled state, and
a blanket layer that takes an outer circumferential side of the blanket in the rolled state.

5. The rotary printing press according to claim 2, wherein the cocking device includes
an eccentric shaft bearing that supports one end of a rotation shaft of the plate cylinder, and
a rotating mechanism that rotates the eccentric shaft bearing around the rotation shaft.

6. The rotary printing press according to claim 5, wherein
the rotating mechanism includes a cocking driving source for rotating the eccentric shaft bearing, and
the cocking device further includes a cocking control unit that controls the cocking driving source.

7. The rotary printing press according to claim 1, comprising a lateral-registration correcting device that is arranged to approach the conveyed web, the lateral-registration correcting device restoring the web that is stretched in a width direction.

8. The rotary printing press according to claim 7, wherein the lateral-registration correcting device includes
a roller group that is constituted by a plurality of rollers that can have a rolling contact with the conveyed web, the rollers being arranged in the width direction, and
a roller-group moving mechanism that moves the roller group back and forth in a contacting direction with the web.

9. The rotary printing press according to claim 8, wherein
the roller-group moving mechanism includes a lateral-registration correction driving source for moving the roller group back and forth in the contacting direction, and
the lateral-registration correcting device further includes a lateral-registration-correction control unit that controls the lateral-registration correction driving source.

10. The rotary printing press according to claim 7, wherein the lateral-registration correcting device includes
a nozzle group that is constituted by a plurality of nozzles that can blow an air against the conveyed web, the nozzles being arranged in the width direction of the web, and
an air supplying unit that is configured to supply the air to the nozzle group through an air supplying path.

11. The rotary printing press according to claim 1, wherein
a plurality of print pages of a predetermined size with a predetermined page width and a predetermined page length are printed on the web across a conveying direction and the width direction of the web after printing, and
the plate cylinder body is formed such that the cylinder width in the axial direction is as wide as four pages of the page width and the circumferential length in the circumferential direction is as long as one page of the page length.

12. The rotary printing press according to claim 11, wherein
the blanket cylinder includes
a blanket cylinder body around which two blankets are rolled,
two blanket insertion grooves that are formed on a circumferential surface of the blanket cylinder body along an axial direction thereof, into which a leading edge and a trailing edge of the blankets can be inserted, respectively,
the blanket cylinder body is formed such that a cylinder width in the axial direction is as wide as four pages of the page width and a circumferential length in a circumferential direction thereof is as long as two pages of the page length, and
each of the two blanket insertion grooves is formed with a length that is a half of the cylinder width of the blanket cylinder body,
the two blanket insertion grooves are formed at positions facing each other across a rotation shaft of the blanket cylinder body, and
one of the blanket insertion grooves is formed at one end side of the blanket cylinder body, and other of the blanket insertion grooves is formed at other end side of the blanket cylinder body.
